(19) United States
(12) Patent Application Publication
(10) Pub. No.: US 2012/0178062 A1
(43) Pub. Date: Jul. 12, 2012

(54) Haptic Interface for Simulator, Such as a Colonoscopy Simulator

(75) Inventors: Lionel Flaction, Chavannes-Renens (CH); Evren Samur, Chicago, IL (US); Pascal Maillard, Lausanne (CH)

(73) Assignee: ECOLE POLYTECHNIQUE FEDERALE DE LAUSANNE, Lausanne (CH)

(21) Appl. No.: 13/393,991

(22) PCT Filed: Sep. 6, 2010
(86) PCT No.: PCT/IB10/53997

§ 371 Date: Mar. 29, 2012

(30) Foreign Application Priority Data
Sep. 4, 2009 (CH) 01371/09

(51) Int. Cl. G09B 19/00

(52) U.S. Cl. 434/219

(57) ABSTRACT

A device for endoscopic simulation includes an endoscopic interface with a guiding tube for guiding an endoscope. The tube is mounted on bearings for free rotation and includes windows for allowing a contact between the endoscope and friction rollers for tracking axial displacement of the endoscope and for imposing a linear force feedback on the endoscope. One friction roller is connected to a motor for transmission of torque generated by the motor. Another friction roller is connected to an encoder for tracking its axial displacement. The device further includes an axial brake for blocking axial movement of the endoscope while allowing rotation of the endoscope. The axial brake includes two pairs of brake rollers placed around the endoscope. One pair of brake rollers is movable relatively to another pair for realizing the axial blocking. One friction roller is mounted on the tube via a lever actuated by spring means for allowing smooth insertion of endoscopes having different sizes and ensuring sufficient contact force on the endoscope of the brake rollers.

### FIELD OF THE INVENTION

The present invention concerns interfaces using simulators for training of surgical procedure and more particularly to a haptic interface for a colonoscopy simulator.

### BACKGROUND ART

Colonoscopy is a minimally invasive surgery procedure where the colon of a patient is examined with an endoscope. The instrument is called a colonoscope which is a long flexible tube with an integrated imaging device at its tip. The colonoscope allows physicians to treat lesions while visualizing the colon. Due to difficult hand-eye coordination, complicated guidance of the flexible endoscope and the risk of colon injury, these techniques need to be performed by highly trained end experienced physicians. The importance of training colonoscopy procedures rises with the growth of variety of colon diseases and growing need to screen as a preventative measure.

Some training for colonoscopy is performed on real patients once the physician has passed his/her novice level. This increases the risk to the patient and lengthens the procedure time.

Computer-based training of such procedure with virtual reality (VR) visualization and haptic feedback offers flexible and repeatable scenarios without risk for the patient. Furthermore, it allows session recording and has therefore distinct advantages over traditional training methods on animals, cadavers or real patients.

Since several years, there has been research on virtual reality surgery simulators which haptic feedback, the main goal being thus to provide an alternative to traditional training methods. Haptic feedback is a key feature for every surgery simulator for such training. A haptic interface in a surgery simulator not only measures position and orientation of a surgical tool but also provides appropriate force and torque feedback associated with the surgical procedure. Virtual reality with haptic technology ensures more realistic training.

In the prior art, several devices and systems have been described. For example EP 0 803 114 to Immersion Corp., the content of which is incorporated by reference in the present application, discloses a human/computer interface device for stimulating medical procedures which is particularly well adapted to simulations requiring between two and four degrees of freedom, and especially two degrees of freedom, such as for simulations of catheter procedures.

The device disclosed comprises a virtual reality system used to simulate a medical procedure including a human/computer interface apparatus, an electronic interface and a computer. The virtual reality system is directed to a virtual reality simulation of a catheter procedure. The software of the simulation is commercially available, e.g., from Immersion Human Interface Corporation of Palo Alto, Calif., USA.

A catheter used in conjunction with the device is manipulated by an operator and virtual reality images are displayed on a screen of the digital processing system in response to such manipulations. Preferably, the digital processing system is a personal computer or workstation.

In addition to a standard catheter, the human/interface apparatus includes a barrier and a “central line” through which the catheter is inserted into the body. The barrier is used to represent a portion of the skin covering the body of a patient. Preferably the barrier is formed from a mannequin or other life-like representation of a body or body portion, e.g., the torso, arm or leg. Central line is inserted into the body of the patient to provide an entry and removal point from the body of the patient for the catheter, and to allow the manipulation of the distal portion of the catheter within the body of the patient while minimizing tissue damage. Catheter and central line are commercially available from sources such as Target Therapeutics of Fremont, Calif., USA and U.S. Surgical of Connecticut, USA. Preferably, the catheter is modified such that the end of the tool (such as any cutting edges) are removed, leaving only the handle and the shaft. The end of the catheter tool is not required for the virtual reality simulation, and is removed to prevent any potential damage to persons or property.

The catheter includes a handle or “grip” portion and a shaft portion. The grip portion can be any conventional device used to manipulate the catheter, or the grip may comprise the shaft portion itself. The shaft portion is an elongated flexible object and, in particular, is an elongated cylindrical object. The device is concerned with tracking the movement of the shaft portion in three-dimensional space, where the movement has been constrained such that the shaft portion has only two, three or four degrees of motion.

This forms a simulation of the typical use of a catheter in that once the catheter is inserted into a patient, it is limited to about two degrees of freedom. More particularly, the shaft is constrained at some point along its length such that it can move with two degrees of freedom within the patient's body.

The electronic interface is part of the human/computer interface apparatus and couples the apparatus to the computer. More particularly, the interface is used in preferred embodiments to couple the various actuators and sensors contained in the apparatus to a computer.

The electronic interface is coupled to a human/computer interface of the apparatus by a cable and is coupled to the computer by another cable. In some embodiments, the interface serves solely as an input device for the computer. In other embodiments, the interface serves solely as an output device for the computer. In yet other embodiments, the interface serves as an input/output (I/O) device for the computer.

The apparatus disclosed includes an object receiving portion into which an elongated flexible object, such as a catheter, is introduced through an aperture. The elongated flexible object passes through the interior of the object receiving portion, the interior of which receiving portion includes one or more electromechanical transducers coupled with the object receiving portion and associated with the elongated flexible object, such as actuator and translation transducer. The elongated flexible object exits the object receiving portion through a second aperture whereupon the elongated flexible object passes through rotational transducer which rotational transducer is rotatably coupled to the object receiving portion.

Translation transducer includes a wheel which wheel is mounted on a shaft coupled to a sensor which sensor is coupled to object receiving portion by a base. Translation transducer is adapted to determine translational motion of elongated flexible object by sensing positions of the elongated flexible object along the direction of translation thereof and producing electrical signals corresponding to the positions. Wheel engages elongated flexible object with a normal force such that translation of elongated flexible object causes rotation of shaft end creating an electrical signal from sensor which is recorded by the interface. It will be appreciated that translation transducer could also be an output transducer and apply a frictional braking force to elongated object to simulate such effects as drag experienced by the catheter as the catheter traverses various vessels in the body.

Another example of a prior art device is described in U.S. Pat. No. 6,926,531 to KeyMed, the content of which is incorporated by reference in the present application. This document discloses an apparatus for use in a simulator for an endoscopy system. The apparatus comprises a rotatable disc on which a plurality of rollers are mounted to surround the axis of rotation of the disc. A force feedback motor is provided to resist rotation of the disc and a further motor is provided to resist rotation of at least one of the rollers. These mechanisms provide rotational and linear force feedback respectively against movement of a dummy instrument inserted along the axis. A separate mechanism of similar construction, but without force feedback motors is provided independently of the force feedback arrangement to provide independent linear and rotary sensing of the position of the instrument. In this patent, the main idea concerns an apparatus characterized in that the tactile means comprises means to impart linear and rotational force feedback independently of one another, including a set of rollers spaced circumferentially around the duct such that the periphery of each roller engages, in use, the insertion tube and each roller is rotatable upon longitudinal movement of the tube; the rollers being arranged to grip the tube and being mounted on a disc which is rotatable upon rotational movement of the tube, a first force feedback mechanism for generating proportional resistance to rotation of at least one roller so as to provide force feedback against the longitudinal motion of tube, and a second force feedback mechanism for generating proportional resistance to rotation of the disc so as to provide force feedback against the rotational movement of the tube, wherein the rollers are configured to grip the tube so as to substantially eliminate slippage between the tube and the disc as the tube is rotated. By providing the tactile means independent of the sensing means, problems identified in the prior art are avoided. Even if the dummy instruments slips with respect to the tactile means when a high level of force feedback is applied, as the sensor means is independent, it will continue to monitor the position of the instrument. In other words, by being independent, the sensor means operates at a constant force and can be designed accordingly, while, in the prior art, the sensing means has to engage with the instrument through an ever changing degree of force.

Other prior art publications disclosing simulation devices are patents U.S. Pat. No. 5,821,920 to Immersion Human Interface Corporation and U.S. Pat. No. 6,038,488 to Bertec Corporation, the content of which are incorporated by reference in the present application.

In addition, several articles describe such haptic interfaces (all incorporated in their entirety by reference in the present application):

1) HELLIER David et al., “A Modular Simulation Framework for Colonoscopy using a new Haptic Device”, 16th Medicine Meets Virtual Reality Conference, February 2008.
2) SAMUR Evren et al., “A Haptic Interface with Motor/Brake system for Colonoscopy Simulation”, 16th Symposium on Haptic Interfaces for Virtual Environments and Teleoperator Systems, March 2008.

### 3) MAILLARD Pascal et al., “Instrumentation of a Clinical Colonoscope for Surgical Simulation”, 30^{th} Annual International IEEE EMBS Conference, Vancouver, British Columbia, Canada, Aug. 20-24, 2008.

### 4) ILIC Dejan et al., “Real-Time Haptic Interface for VR Colonoscopy Simulation”, 13th Medicine Meets Virtual Reality Conference, February 2005.

5) IKUTA Koji et al., “Portable Virtual Endoscope System with Force and Visual Display”, Proceedings of the 2000 IEEE/RSJ International Conference on Intelligent Robots and Systems.

During a typical endoscopic procedure such as colonoscopy, the endoscope is inserted and rotated along the colon. Therefore, the linear and rotational workspace of a simulator should be practically unlimited for a realistic application. In addition, tool re-insertion is also required. Forces and torques felt during such a procedure are also high. Considering these requirements, a simulator with force feedback can be designed to work with adapted endoscopes.

### SUMMARY OF THE INVENTION

It is an aim of the present invention to improve the known devices and methods.

More specifically, it is an aim of the present invention to provide a device and method for simulating a surgical procedure, for example a colonoscopy with an endoscope by means of a haptic interface.

A further aim of the present invention is to propose a simulation device that is more accurate and that allows a better training of users.

Features of the device according to the present invention are defined in the appended independent claims.

Dependent claims define specific embodiments of the present invention.

An idea of the present invention is to provide a haptic interface that acquires position of an endoscope (for ex. colonoscope) and provides force feedback at least in axial and rotational directions. Combined electrical motors and passive brakes are used to cover a large range of forces. DC motors are used to simulate the friction of the endoscope when inserting through the natural orifices (for ex. colon). A power brake and a mechanical brake are used if respectively torques or forces applied on the endoscope are too strong to be maintained by the motors. The haptic interface provides high translational force and rotational torque. This design allows motion in one direction while impeding the other. The interface has an unlimited workspace. Endoscopes of different sizes can be inserted and removed.

An axial braking system allows rotational motion of endoscopic devices. The particular design of the brake enables to lock the axial linear displacement while maintaining the rotational degree of freedom. DC motor activates the lever system. Four rollers compress the inserted tool blocking the linear displacement. Rotation of the rollers enables the rotation of the inserted tool even when the linear displacement is blocked.

In addition, the device according to the invention provides brake release without force measurement for haptic interfaces.

Accordingly, the brake system is mounted on rails in a carriage. Springs are placed on each side of the carriage in order to set the position of the brake system while preserving slight linear displacement. Attempts to withdraw the endoscope when the brake is activated results in a slight linear displacement measurable for example through an encoder used for the axial tracking. Such a measured displacement results in the releasing of the brake. However, the brake remains active in case the user keeps providing insertion force to the endoscope.

A surgical simulation device acquires position of an endoscope (for ex. colonoscope) and provides force feedback in axial and rotational directions. FIG. 1 shows an example of such a device and components. As mentioned previously, combined electrical motors and passive brakes are used to cover a large range of forces. Electrical motors are used to simulate the friction of the endoscope when inserting through the natural orifices (for ex. colon). A powder brake and a mechanical brake are used if respectively torques or forces applied on the endoscope are too strong to be maintained by the motors. A brake release system is employed without additional costly hardware. This novel design allows motion in one direction while impeding the other. The interface has an unlimited workspace. Endoscopes of different sizes can be inserted and removed while providing sufficient contact force for high translational force and rotational torque feedback. This novel design of the endoscopic interface allows tracking of independent axial and rotational motion of different size endoscopic devices and providing force feedback.

The device should provide position data acquisition and force feedback in linear and rotational directions. Mechanical brakes can be used to generate required high forces. Therefore the device should allow smooth insertion of endoscopes and proper contact force. Also a brake release system is crucial.

An endoscope, such as a colonoscope, is inserted in the device through a transversal guiding tube. The tube contains windows to allow the contact between the colonoscope and a pair of friction rollers. The rollers are used to track the linear displacement of the colonoscope and to impose axial force feedback, but they also ensure the contact for the rotational movement of the colonoscope. The rollers are connected to a motor through a series of gears. The rotational part is fixed on bearings and the electrical connection is provided by a slip-ring pair that allows an infinite rotational movement of the colonoscope. This rotational movement is also linked to a DC motor by means of gears.

The device includes DC motors for active force feedback and friction compensation as well as brakes for high force rendering. A 2 DOF (degree of freedom) mechanical brake is designed to be used with the maximum force that can be exerted by the motor in linear direction. The brake is released as soon as the colonoscope is moved backward. To make it possible, the brake system is fixed on linear guidance rails and is constrained by springs of different stiffnesses. The mechanical brake contains four cylinders fixed on bearings. When the brake is closed, all the cylinders compress the colonoscope, impeding the linear displacement, but still allowing rotational movement of the colonoscope. Two optical position encoders for linear and rotational displacements are tracked individually.

### BRIEF DESCRIPTION OF THE DRAWINGS

FIG. 1 shows a general perspective view of the device according to the invention;

FIG. 2 illustrates a general perspective view of the device according to the invention as illustrated in FIG. 1 but seen from the back;

FIGS. 3 and 4 show a more detailed view of the endoscopic interface of the device according to the present invention;

FIG. 5 illustrates a cut view of the interface presented on FIG. 3;

FIG. 6 illustrates a perspective view of a brake system of the device according to the invention;

FIG. 7 illustrates a part of the brake system according to the invention and

FIG. 8 illustrates a cut view of the brake system presented on FIG. 6.

### DETAILED DESCRIPTION OF THE INVENTION

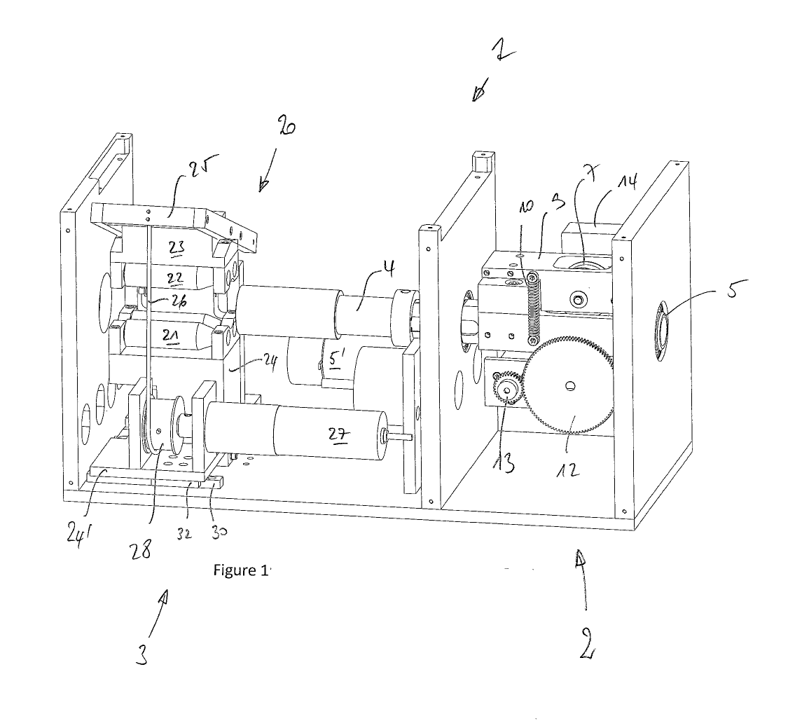

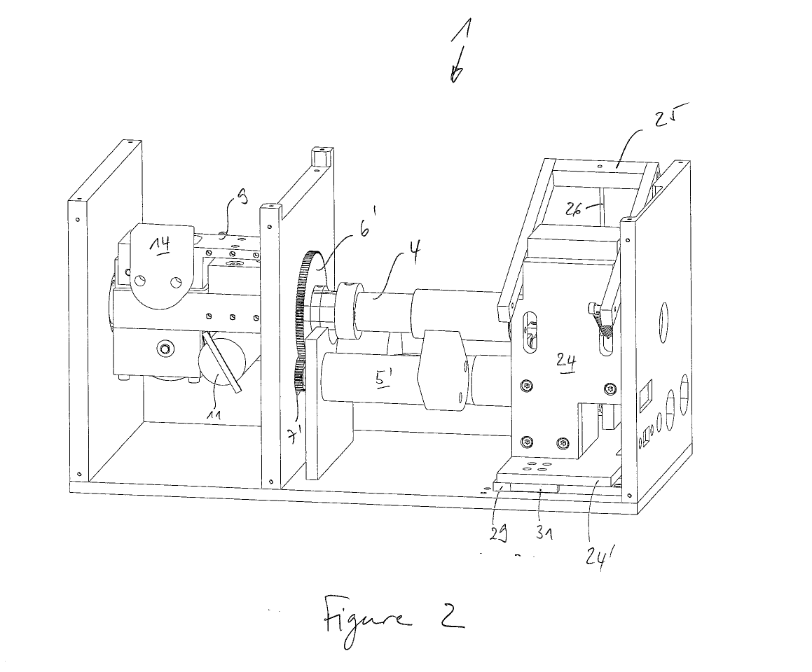

A general perspective view of the device 1 according to the invention is illustrated in FIGS. 1 and 2. More specifically as mentioned above, the device 1 according to the invention is used to simulate the use of a medical device, in this case an endoscope, in a human body. It thus comprises a first part 2, called an endoscopic interface, which carries a system measuring the axial displacement of an endoscope (for example) and also its rotation and at the same time is able to provide linear et rotational force feedback to the endoscope. The device also has a second part 3 which comprises a brake system that will be explained in a detailed manner hereunder.

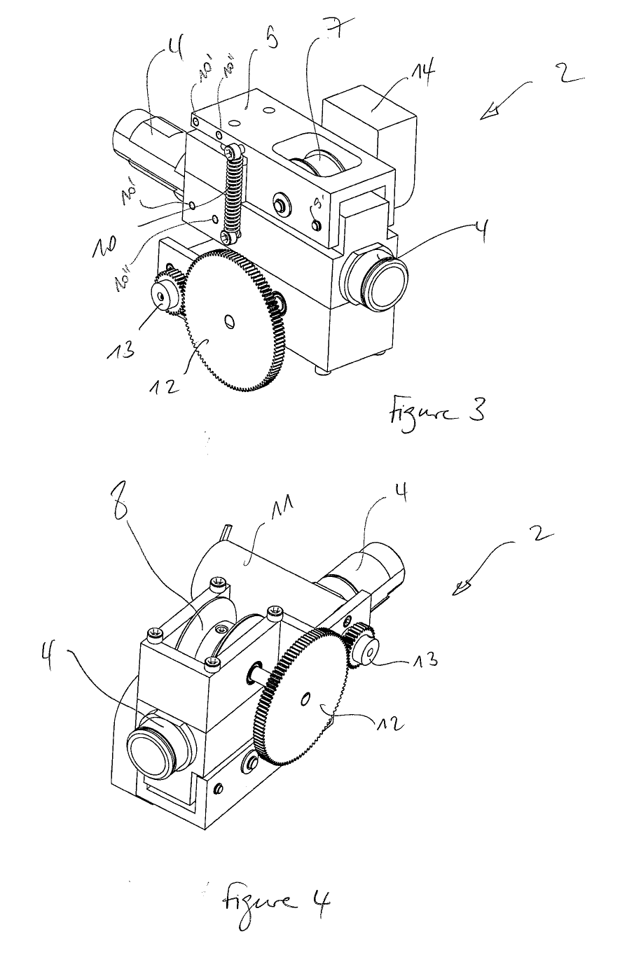

FIGS. 3, 4 and 5 shows a detailed view of the endoscopic interface 2.

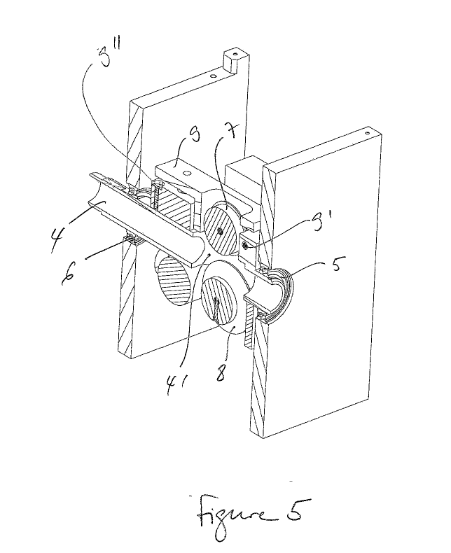

A transversal guiding tube 4 is mounted on fixed bearings 5, 6 (see FIGS. 1, 2 and 5) for free rotation around the insertion axis. An electrical connection is provided by a slip-ring pair that allows an infinite rotational movement of the tube 4 and the transmission of the electrical signals. This rotational movement is linked to an electrical motor 5′ by means of gears 6′, 7′ (see FIG. 2) to allow motion detection and force feedback in the rotational direction. An endoscope, such as a colonoscope, is inserted into the device through this transversal guiding tube 4. The tube 4 contains windows 4′ to allow the contact between the colonoscope and a pair of friction rollers 7, 8. As soon as the endoscope engages with the rollers 7,8 axial and rotational tracking and also actuation is ensured, respectively made possible. The friction rollers 7, 8 allow removing and re-inserting the endoscope. The rollers 7, 8 are used to track the axial displacement of the colonoscope and in addition to impose axial linear force feedback, but they also ensure the contact for the rotational movement of the colonoscope. One of the friction rollers 8 is attached on the transversal guiding tube 4 through bearings. The other roller 7 is mounted to the same tube 4 by means of a lever 9 which is fixed by a revolute joint 9′. The lever structure 9 is equipped with at least one mechanical spring means 10 to ensures sufficient contact force on the endoscope with the roller 7 while allowing smooth insertion of different size of endoscopes. This results in freedom to use different size of endoscopes with irregular surface the system described allowing to compensate for the size differences and also irregular surfaces. A screw 9″ fixed to the tube 4 is using as a mechanical stop for the lever 9. Varying the length of the exposed part of the screw modify the minimal diameter of aperture depending of the diameter of the endoscope which is used. Preferably, but not exclusively, the screw is made of a plastic or synthetic material. Of course, other equivalent means may be envisaged. One of the friction rollers is shaped as V-type pulley (reference 8 in FIGS. 3 and 5) to balance the force acting on the endoscope and improve the contact between the friction rollers 7, 8 and the endoscope for proper force feedback in axial and rotational degrees of freedom. One of the friction rollers (for example roller 8 in FIG. 4) is connected to an electric motor 11 through a series of gears 12, 13 for transmission of torque generated by the motor 11 to the endoscope. The other one is engaged with an encoder 14 for the tracking of the tool axial displacement. Decoupling of actuation and tracking systems avoids loss of position tracking data due to an unlikely slippage of the endoscope over the friction rollers 7, 8.

The design of the endoscopic interface according to the present invention allows tracking of independent axial and rotational motion of different size of endoscopic devices and providing force feedback at the same time.

The spring 10 is combined to an adjustable structure to ensure a proper contact between the friction rollers 7, 8 and the endoscope that has been introduced. The adjustable structure is made of various thread 10′, 10″ to fix the spring at different lengths, varying the contact force between the friction rollers 7, 8 and the endoscope depending on the attachment positions of the spring (as illustrated or in 10′ or 10″, or even crossed). This results in freedom to use different size of endoscopes with irregular surface. Decoupling the motor used for force feedback and the encoder tracking the linear displacement avoid loss of position data due to an unlikely slippage of the endoscope.

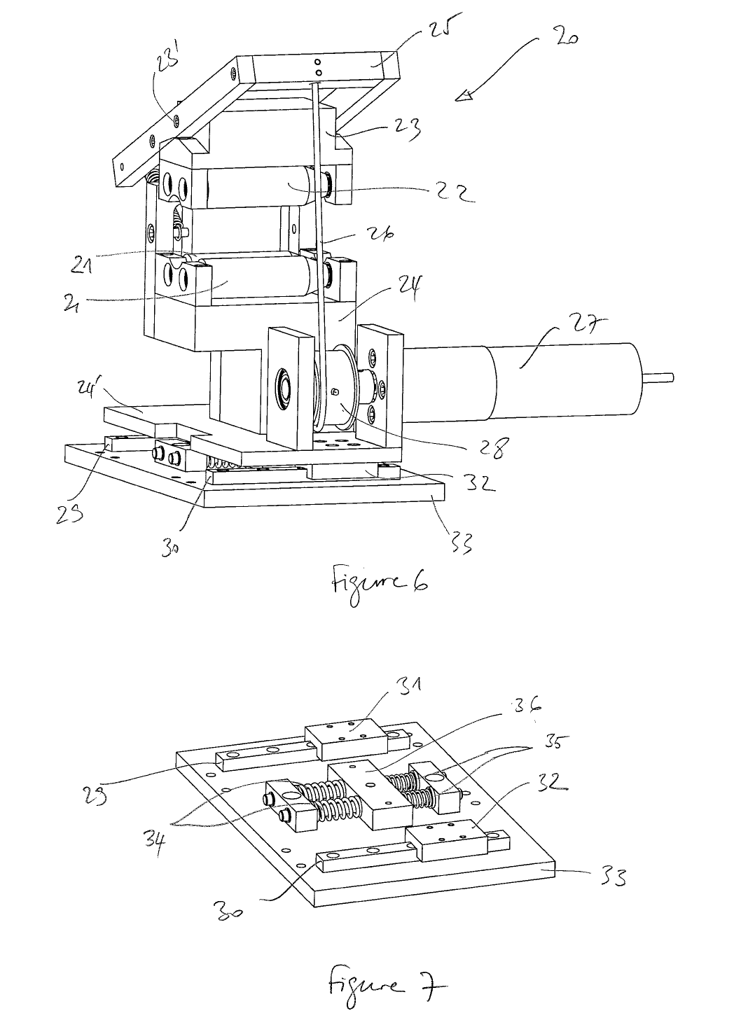

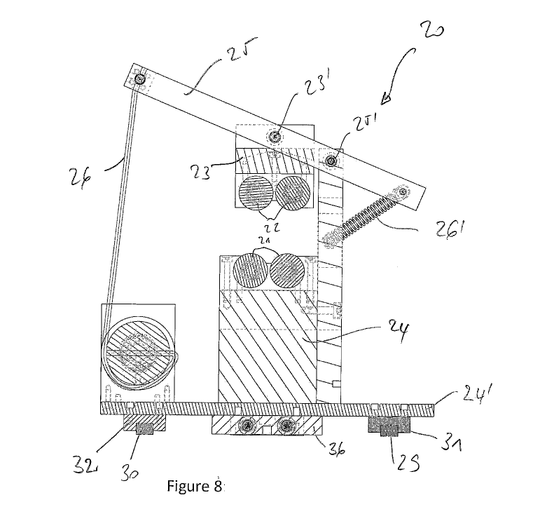

The present invention provides a release system for a mechanical brake used in endoscopic simulators such as a colonoscopy simulator (see FIGS. 6 to 8).

A mechanical brake is used to provide high forces which cannot be exerted by a small size electrical motor. The brake locks the axial linear displacement while maintaining the rotational degree of freedom.

An electrical motor activates the lever system comprising four rollers. As previously mentioned, the rollers compress the inserted endoscope blocking the axial displacement. Rotation of the rollers enables the rotation of the inserted endoscope. The brake system is mounted on two linear guidance rails. Springs are placed on each side of the carriage in order to set the position of the brake system while preserving slight linear displacement. Attempt to withdraw the endoscope when the brake is activated results in a slight linear displacement measurable through the encoder used for the axial tracking. Such a displacement results in the release of the brake as will be described in more detail below. The brake remains active in case the user keeps providing insertion force to the endoscope. This solution allows to detect any change of force applied to the system by the operator without using additional sensors such as force/pressure sensors for example.

More specifically, as illustrated in the drawings, the endoscope further goes through a second part 3 of the device which part comprises in particular a linear brake 20 (see FIGS. 6-8). This linear brake comprises at least two pairs of rollers 21, 22 facing each other, said rollers 21, 22 having a generally cylindrical shape (preferably a conical shape) and being disposed in parallel with the axis of the endoscope and free to rotate around their axis being mounted on bearings.

Rollers 22 are mounted on a movable part 23 and the part 24 holds the rollers 21. Part 23 is fixed on bearings which allows the rollers 22 to remain always perpendicular to the rollers 21 independently of their position and/or the diameter of the endoscope. As illustrated in FIG. 8, movable part 23 may be attached to the handle by an axis 23′ or by any other equivalent means. The tip of the rollers are preferably conically shaped to guide the endoscope to the center. This together with rotatable part 23 allows a proper engagement of the rollers with the endoscope. Part 23 is movable towards and away from the part 24. This movement is created by handle 25 actuated by pulling element 26 (for example a string) itself being pulled by the motor 27 with a pulley 28. More specifically, the motor 27 is used to rotate the pulley 28, thus pulling the element 26 and by way of consequence pulling the handle 25 downwards, said handle 25 being mounted on an axis 25′ allowing its rotation around said axis 25 when pulled downwards according to the functioning described above. This has the effect of compressing the endoscope between the rollers 21, 22 thus reducing and finally blocking the axial movement of said endoscope, while still allowing a rotation of the endoscope since the rollers 21, 22 are mounted on bearings. Preferably, the system comprises in addition a spring means 26′ (see FIG. 8) for disengaging the brake when not activated.

This brake is used to simulate, for example, the pushing of the endoscope against the wall of the body part being inspected, for example the colon. Indeed, in such a situation, a colonoscope should not be allowed to move forward but still be rotated. However, if the colonoscope is pulled backwards, then the brake should be released at that moment to maintain the simulation process and imitate the reality.

The brake is also used to simulate effects such as high forces generated due to the friction between the endoscope and the colon while the endoscope traverses the colon (or another simulated body part). Such a force can be higher than the force that can be generated by motor 11 and the transmission system comprising parts 8, 12 and 13. At that level, while motor 11 maintains the maximum torque, the torque on the motor 27 is gradually increased depending on the force that is to be simulated. This results in smooth and continuous force rendering. The brake can generate friction forces from 0 to very high forces for example 100 N that completely blocks the movement.

Accordingly, in order to imitate the natural behavior, the above described brake is mounted trough a plate 24′ on rails 29, 30, parallel to the general direction of the colonoscope, said rails being attached to a frame 33 through gliding parts 31, 32 and is also connected to the frame 33 supporting said rails 29, 30 via two pairs of springs 34, 35 having different properties, e.g. different stiffness, which also imitate the reality (for example the resistant to deformation of the colon wall) actuated by an actuation plate 36 attached to the brake system 20. The rails 29, 30 are disposed substantially parallel to the axis of the endoscope to allow the displacement of the longitudinal brake system 20 in this direction. The frame 33 may be formed, for example by a wall of the device.

When the device is supposed to simulate a contact of the tip of the endoscope against the wall of the body part, the brake system 20 is activated thus blocking the relative motion of the endoscope with respect to the brake system 20 and moving the brake system with the endoscope. As can be understood from the above description and from the drawings, only the longitudinal relative motion is thus blocked but the endoscope is still able to rotate by the use of the rollers 22, 23.

Accordingly, a first pair of springs 34 is put under stress to simulate the elastic behavior of the wall that would block a forward motion of the endoscope until a certain value is reached.

As soon as the endoscope is pulled backwards against the second pair of springs 35, this backward motion (even small) is detected, for example via the encoders tracking the axial motion of the endoscope, because the springs 34 allow such a motion and the brake is released either partially or entirely to take account of this backward motion.

Preferably, these movements of the endoscope and consequently of the brake system 20 are measured by sensors, for example the sensors (or encoders) used for the axial motion tracking of the endoscope as mentioned above or other dedicated sensors. As will readily be understood by a skilled man, in such a case it is necessary to allow a relative movement of the brake system in order to be able to detect in particular a backwards motion of the endoscope when the brake is closed. Otherwise, the system will be blocked and the brake will have to be released directly because a backward motion will not be detectable easily, if possible.

Accordingly and as described above, the measured (even small) backward movement will have the effect of releasing the brake at least partially and thus imitate a natural behavior. Preferably, the brake remains active in case the user, after a backward movement again executes a forward motion in the same direction as previously such that the system is again active as described above and a linear motion is prevented while a rotation is still allowed.

The springs 34, 35 have typically the following characteristics: Both allow maximum displacement of approximately ±6 mm. The pair of springs 34 has a stiffness constant of 30 N/mm which can generate a maximum force of 180 Newtons. This high force prevents the movement in insertion direction. Indeed, a 4 mm movement creates a reaction force of 10 kg which feels as a hard wall.

The pair of springs 35 has a lower stiffness constant of 4 N/mm which allows backward movements but still keeps the system balanced and stationary when the brake is off. Resolution of the position sensing in axial direction is 0.04 mm. Thus, a backward movement of 0.04 mm can be sufficient to release the brake. This creates only a reaction force of 1 gram which cannot be detected by the users.

Typical values or ranges of movements that can be considered are the following: 3 mm in insertion direction and 0.04 mm in backward direction. In other embodiments, the backward detected movement can be in the range from about 1 μm to 6 mm. Of course, in this case, the sensor used should be adapted to this range.

Of course, other values may be envisaged depending on the application and the simulated body part (colon, esophagus etc). Indeed, while the application described above relates to colonoscopy, the present device may be used for the simulation of other procedure than colonoscopy, where a endoscope or similar device is to be used.

As one will readily understand, the examples given in the present description and drawings are purely illustrative and should in no way be construed in limiting fashion. Equivalent means may perfectly be envisaged by a person skilled in the art.

For example, the values given above for the springs are examples and other values may be considered depending on the circumstances. For example, the values may depend on the body part that is simulated by the device or may adjusted depending on the simulation carried out.

Also, other means equivalent to the one described above may be used in the frame of the present invention. For example the actuation means for the brake system maybe replaced by equivalent means as also the motors and gears used for movement detection and force feedback.

Preferably, the friction rollers 7, 8 are in metal, for example aluminium. Of course other suitable material may be envisaged in the frame of the present invention.

In addition one may add rubber on the circumference of the rollers 7, 8 to improve their contact with the endoscope and avoid a slipping during introduction of the endoscope and/or simulation.

1.-15. (canceled)

16. A device for endoscopic simulation, the device comprising:
an endoscopic interface with a guiding tube for guiding an endoscope, the tube being mounted on bearings for free rotation, the tube including windows for allowing contact between the endoscope and friction rollers for tracking axial displacement of the endoscope and for imposing a linear force feedback on the endoscope, at least one of the friction rollers being connected to a motor for transmission of torque generated by the motor, at least one other of the friction rollers being connected to an encoder for tracking of its axial displacement; and
an axial brake for blocking axial movement of the endoscope while allowing rotation of the endoscope, the axial brake comprising at least two pairs of brake rollers placed around the endoscope, at least one pair of the brake rollers being movable relatively to at least one other pair of the brake rollers for realizing the axial blocking;
wherein at least one of the friction rollers is mounted on the tube via a lever actuated by spring means for allowing smooth insertion of endoscopes having different sizes and ensuring sufficient contact force on the endoscope of the brake rollers.

17. The device of claim 16, wherein the axial brake is mounted on rails attached to the spring means for allowing a reduced displacement of the endoscope even in case of a closed axial brake in order to open the axial brake when detecting the reduced displacement.

18. The device of claim 17, wherein the spring means attached to the rails have a different stiffness.

19. The device of claim 18, wherein the stiffness in the forward direction is higher than the stiffness in the backward direction.

20. The device of claim 17, wherein the reduced displacement is a backward movement detected via the friction roller connected to the encoder.

21. The device of claim 20, wherein the backward movement is in the range of about 1 μm to 6 mm.

22. The device of claim 16, wherein the spring means have characteristics that depend from the part that is simulated by the device.

23. The device of claim 16, wherein the linear displacement allowed by the spring means is about ±6 mm.

24. The device of claim 16, wherein at least one of the friction rollers has the shape of a V-type pulley to balance the force acting on the endoscope and improve the contact between the friction rollers and the endoscope.

25. The device of claim 16, wherein at least one pair of brake rollers is mounted on a movable part that is attached to bearings such that the brake rollers are always parallel independently of the position of the movable part and/or the diameter of the endoscope.

26. The device of claim 16, wherein the brake rollers have a conical shape.

27. The device of claim 16, wherein the axial brake is usable to simulate high force generated by friction between the endoscope and the simulated part of the body.

28. The device of claim 16, wherein the friction rollers comprise rubber on their surface in contact with the endoscope.

29. The device of claim 16, wherein the lever and a mechanical stop allow adjustment to the minimal diameter aperture for the endoscope.

30. The device of claim 16, wherein the contact force between the friction rollers and the endoscope is modified by using different attachment position of the spring means.

31. The device of claim 16, wherein the spring means comprises a first pair of springs and a second pair of springs.

32. The device of claim 31, wherein the second pair of springs has a lower stiffness constant than the first pair of springs.

33. The device of claim 31, wherein:
the first pair of springs has characteristics for generating a high force preventing forward movement of the endoscope in the insertion direction; and
the second pair of springs has characteristics for allowing backward movement of the endoscope while keeping the device balanced and stationary when the axial brake is off.

34. The device of claim 31, wherein the first and second pairs of springs allow maximum displacement of about ±6 mm.

35. The device of claim 31, wherein:
the first pair of springs has a stiffness constant of 30 N/mm, which can generate a maximum force of 180 Newtons; and/or
the second pair of springs has a stiffness constant of 4 N/mm; and/or
the backward detected movement is in the range of about 1 μm to 6 mm; and/or
the range of movement is 3 mm in the insertion direction and 0.04 mm in the backward direction.
